(19) United States
(12) Patent Application Publication
(10) Pub. No.: US 2008/0208471 A1
(43) Pub. Date: Aug. 28, 2008

(54) METHOD FOR FINDING A POSITION FOR LANES ON A MULTILANE ROADWAY

(76) Inventors: Ulf Noyer, Braunschweig (DE); Nico Niehoff, Sickte (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/035,075

(22) Filed: Feb. 21, 2008

(30) Foreign Application Priority Data
Feb. 26, 2007 (DE) 10 2007 009 638.2

(51) Int. Cl. G06F 19/00

(52) U.S. Cl. 701/300

(57) ABSTRACT

The invention relates to a method for finding a position for lanes on a multilane roadway, where first of all the position of a first lane on the multilane roadway is found and then the position of at least one further lane on the multilane roadway is determined on the basis of the position found for the first lane.

### BACKGROUND OF THE INVENTION

1. Field of the invention

The invention relates to a method for finding a position for lanes on a multilane roadway.

2. Description of the Related Art

To produce digital maps, it is necessary, inter alia, for the positions of the roadways which are to be entered into the digital map, such as roads or rails, to be known. To obtain these positions, the relevant roadways are surveyed by virtue of a converted vehicle equipped with at least a position-finding system, particularly a satellite position-finding system, traveling along the roadways to be surveyed. While traveling along the roadway, a multiplicity of measured values are ascertained which represent the position of the roadway at the particular point.

To obtain the most accurate depiction of the relevant roadway possible, it is also necessary for the positions of the individual lanes on multilane roadways to be known. In this context, the method known from the prior art has the drawback that each lane on the multilane roadway needs to be surveyed individually in order to obtain positions of the individual lanes. This can firstly be done by individually surveying each lane, which results in a high level of outlay. Alternatively, it is conceivable for all the lanes on the multilane roadway to be surveyed in one measurement trip, but this absolutely presupposes that the other lanes are free. This normally requires road closure, which results both in holdups for the road traffic and in enormous costs.

In the light of these problems, it is an object of the invention to specify an improved method for surveying multilane roadways.

The invention achieves the object by means of the method of the type cited at the outset by virtue of the position of a first lane on the multilane roadway being found and the position of at least one further lane on the multilane roadway being determined on the basis of the position found for the first lane and the stipulated standard design of roadways.

### SUMMURY OF THE INVENTION

Accordingly, the present invention is based on the idea of using the known position of a lane to infer the positions of the other lanes on the multilane roadway. Advantageously, the lane which is intended to be used to determine the positions of the other lanes is surveyed first. By way of example, this can be done by virtue of a specially converted vehicle traveling along the lane to be surveyed and in this way finding the position of the lane. Next, the position of this lane can then be taken as a basis for inferring the positions of the other lanes.

Advantageously, the position of a lane relates to one of the lane boundary lines. Lane boundary lines mean the lines which bound the lane on the left and right and define the width of the lane. With knowledge of the position of such a lane boundary line for a roadway, it is then possible to infer the positions of the other lane boundary lines for the other lanes.

It is quite particularly advantageous if the position of the right-hand roadway boundary line of the roadway is known. At least in Germany, this right-hand roadway boundary line is normally a white, solid line which marks the side boundary of the road. With knowledge of the position of this right-hand road boundary line, it is then possible to infer the next lane boundary line for the following lane, so that the corresponding position of all lanes can be found in this way.

To use the position of one boundary line to infer the position of another boundary line, it is quite particularly advantageous if the width of the individual lanes is known. In the case of roads which are constructed on the basis of the RAS-Q guideline, the width of each lane is known, since the guideline stringently prescribes the width for constructing a road or the width for constructing individual lanes on a multilane road. This is the case particularly for highways. It is therefore possible to use knowledge of the position of the right-hand roadway boundary line by means of coordinate transformation and knowledge of the width of the lane to infer the next boundary line.

### BRIEF DESCRIPTIO OF THE DRAWINGS

The invention is explained in more detail by way of example with reference to the appended drawings, in which:

FIG. 1 shows a schematic illustration of a three-lane road for which the position of the other lanes is inferred;

FIG. 2 shows a cross-sectional illustration of a three-lane highway in the regular cross-section RQ 37.5.

### DATAILED DESCRIPTION OF THE PREFERRED EMBODIMENT

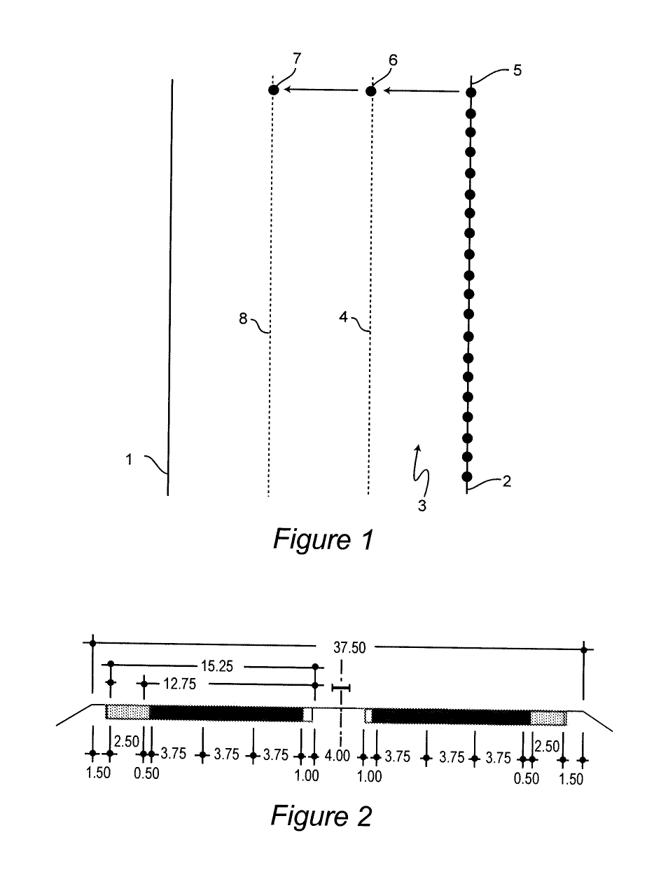

FIG. 1 schematically shows an illustration of a three-lane road 1. The road 1 is bounded on the right by a road boundary line 2. The individual lanes 3 are separated from one another by lane boundary lines 4 and 8. In a first step, the right-hand lane has been traveled along first and in so doing the position 5 of the right-hand boundary line 2 has been found.

With knowledge of the width of the individual lanes 3 on the roadway 1, it is then possible to infer the position 6 of the following lane boundary line 4 by moving the position 5 of the right-hand road boundary line 2 orthogonally by the width of the lane. With knowledge of the position 6 found in this way for the lane boundary line 4, this step can then be repeated and the position 7 of the lane boundary line 8 which follows the lane boundary line 4 can likewise be found. It is therefore possible to use knowledge of the position of a single boundary line to infer the positions of the other boundary lines and hence to define the positions of the other lanes without needing to survey them.

FIG. 2 shows the regular cross section RQ 37.5 of a three-lane highway. It can be seen from this that the individual lanes are 3.75 m wide. The total width of the road is 37.5 m. If the regular cross section used to construct the road is known then the width of the individual lanes is also known. It is therefore no longer necessary to measure out the individual lane widths.

1. Method for finding a position (5, 6, 7) for lanes (3) on a multilane roadway (1), characterized by the position (5) of a first lane (3) on the multilane roadway (1) being found and the position (6, 7) of at least one further lane (3) on the multilane roadway (1) being determined on the basis of the position (5) found for the first lane (3) and the stipulated standard design of roadways.

2. Method according to claim 1, characterized in that the first lane (3) is surveyed first.

3. Method according to claim 1, characterized by the position (6, 7) of a lane boundary line (4, 8) being determined as the position of a lane (3) on the multilane roadway (1).

4. Method according to claim 1, characterized by the position (5) of the right-hand roadway boundary line (2) being determined as the position of the first lane (3) on the multilane roadway (1).

5. Method according to claim 1, characterized by the position (6, 7) of a further lane (3) also being determined on the basis of the width of the lane (3).
